(19) United States
(12) Patent Application Publication
(10) Pub. No.: US 2005/0252279 A1
(43) Pub. Date: Nov. 17, 2005

(54) Apparatus and methodology of hydrostatically testing of oil field tubing and casing

(76) Inventor: Frederic M. Newman, Midland, TX (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 11/087,366

(22) Filed: Mar. 23, 2005

Related U.S. Application Data
(60) Provisional application No. 60/555,938, filed on Mar. 24, 2004.

(51) Int. Cl. G01M 3/04

(52) U.S. Cl. 73/49.5

(57) ABSTRACT

This invention discloses a process which when properly used, automates the hydrostatic testing of casing and/or tubing in a will. An electronic processor with programmable logic provides diagnostics, alarming, and process automation functionality to the process. Current downhole tools and pumps can be used to insure conformance to API specifications, however the processor would sense that a specified target pressure has been reached and start an internal clock. After a specified period of time, the pressure would again be analyzed and compared to the original start pressure. If the decline is within specified limits, one alarm is given and recorded. If the decline in pressure is above the limits, another type alarm could he displayed, heard, and recorded. A PLC can also be incorporated to perform such tasks as starting the pump, closing and opening surface valves, and stopping the pump.

This application is based on U.S. Provisional Patent Application Ser. No. 60/555,938, entitled “An Apparatus and Methodology of Hydrostatically Testing of Oil Field Tubing and Casing” by Frederic M. Newman, filed Mar. 24, 2004, incorporated by reference in its entirety herein.

### BACKGROUND OF THE INVENTION

This invention generally relates to control and interpretive systems dealing with hydrostatic testing of oil field tubing and casing.

Numerous tools are constantly being run into well pipe to perform hydrostatic testing of the pipe and connections. In general, downhole tools consist of a mandrel and upper and lower packing elements and surface tools consist of a fluid pump, hoses, and valves. The downhole mandrel in connected to a fluid pump via a hose.

After a service rig runs the tubing to be tested into the hole, the test mandrel is lowered to the test point (usually 70 feet) and pressure is applied to the inner bore of the mandrel via hose. The application of fluid pressure first expands the packing elements, which in turn seal the mandrel-tubing annular space between the two elements from the rest of the wellbore. With this seal is established, the pumped fluid then enters the tubing-mandrel annular space, thereby replacing air the non-compressible fluid. The operator of the system then increases the pressure to the desired “test” or “target” level, which in effect, pressures up the desired test interval to some predetermined value.

Upon reaching the desired “test” or target pressure, the operator visually observes a pressure gage or, alternatively, references a chart that tracks pressure bleed off (decline). No decline in pressure means no leak in the tubing, while a decline in pressure means there is a hole in the tubing or a faulty connection. If the operator does not see any reduction in pressure, the test is deemed successful the joints and connections are passed. The operator opens a valve and the fluid pressure is allowed to backflow, causing the pressure to approach zero which in turn causes the packing elements to release. The mandrel is then pulled out of the hole, or to another test position, and the process is repeated.

If the operator observes a bleed off or leak, the connection or tubing fails the test and the service crew will then replace the defective joint or coupling. This process, as it is practiced today, requires human input to operate the pump, to observe and interpret the pressure time relationship to determine a good joint or connection, and to release the bleed off valves at the end of the test.

The American Petroleum Institute (API) has set the standards or guidelines for hydrostatic pipe testing in its publication RP5A5 (Recommended Practice) dated May 1, 1989. Under section 4.7.1, 4.7.2, and 4.7.5 one will find the parameters of acceptable testing. In summary, the standard requires that the desired test pressure be applied to the pipe and held for 5 seconds. If the measured pressure after 5 seconds has declined less than a 5% the test pressure, the test is met, and the casing or tubing has passed. Any decline greater then 5% of the test pressure is indicative of a failed test.

There are two major problems with the hydrostatic testing industry in the oilfield today. First, in practice, the API testing procedure described above is preformed by humans and is therefore subject to errors and shortcuts. Actual recorded and observed field data suggest the published API standards are not closely followed as the target pressure is not always obtained on every joint of pipe and the five second observation time standard is almost always ignored. As a result, the hydrostatic test is inaccurate. The second problem that exists today results from the necessity for a human to both perform the test by operating the pump and valves and then for that human to interpret the data to determine either a pass or fail of the inspection or test. This adds expense to the test and introduces the possibility of an oversight.

U.S. Pat. No. 4,081,990, to Chatagnier, discloses a tool for the testing of pipe and connections, however it does not disclose any methodology of an improved actual testing sequence. Likewise U.S. Pat. No. 3,899,920 Matherne discloses another downhole tool for testing, but contains no disclosure of an improved testing sequence. Finally, U.S. Pat. No. 5,439,355 μmison, et al., discloses an apparatus to test for valve leakage as well as self leakage test logic. This system deals with pressure pulses created by the opening and closing of inlet and outlet valves, and therefore operates in a dynamic state. The prior art devices listed above disclose tools used for hydrostatic testing, but do not disclose any process of interpretation of the data for pass or fail, and furthermore do not disclose any automated means of determining the pass/fail status of a joint.

### SUMMARY OF THE INVENTION

This invention discloses a process which when properly used, will eliminate either one or both of the all the inherent obstacles in obtaining a creditable hydrostatic test.

A first embodiment uses an electronic processor with programmable logic for diagnostics, alarming, and process automation. Current downhole tools and pumps can be used to insure conformance to API specifications, however the processor would sense that a specified target pressure has been reached and start an internal clock. After a specified period of time, the pressure would again be analyzed and compared to the original start pressure. If the decline is within specified limits, one alarm is given and recorded. If the decline in pressure is above the limits, another type alarm could he displayed, heard, and recorded. This would eliminate the need for human visual interpretation and the possible subjectivity element thereby insuring a hydrostatic test conforms to the API specified guidelines.

A second embodiment incorporates a PLC circuit to eliminate all human intervention required to start the pump, close and open surface valves, and stop the pump. The PLC can be programmed to handle these routine tasks as well as to sense a pressure, calculate pressure-time decays, alarm the results, and record the data as described in the first embodiment. In this embodiment, the human intervention is limited to simply pressing a starting button, while the system performs the balance of the testing procedure.

### BRIEF DESCRIPTION OF THE DRAWINGS

FIG. 1 illustrates one embodiment of the present invention, a hydrostatic tubing testing block diagram.

FIG. 2 shows a hydrostatic tubing testing control block diagram, a second embodiment of the present invention.

FIG. 3 represents third embodiment of the present invention.

### DESCRIPTION OF ILLUSTRATIVE EMBODIMENTS

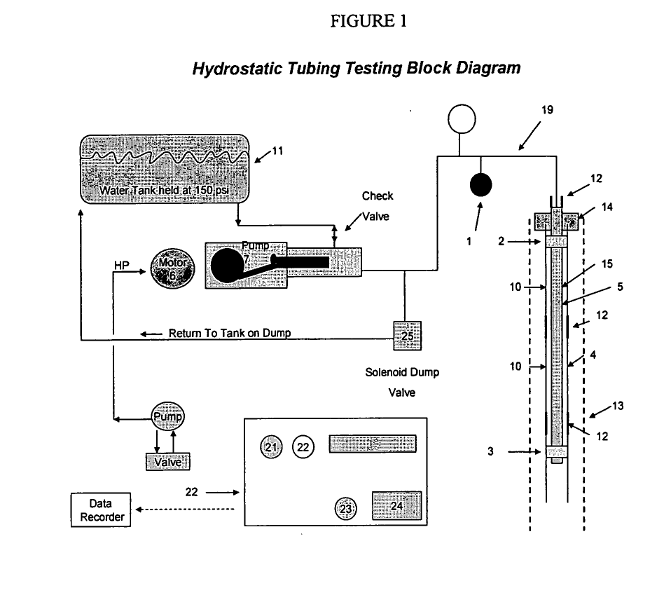

Referring first to FIG. 1, an overview of a hydrostatic tubing testing apparatus/process is shown according to one embodiment of the present invention. First, the testing equipment is set up at the beginning of each job. This done in according with company policy, and is known by virtually all people knowledgeable about hydrostatic testing of casing and tubing. The operator of this system first sets a target pressure in processor (22) to the desired target or test pressure. This can be done using a potentiometer, flip switches, or any input other means know to those skilled in electronics. The operator then presses a learn target icon (21) resulting in processor (22) memorizing the target pressure in memory (24).

The hydrostatic testing sequence then begins. First, tubing joints (10) connected together by couplings (12) are lowered into oil well (13) and are suspended in the oil well (13) by slips (14). Hydrostatic test mandrel (15), similar to that described in U.S. Pat. No. 3,899,920 is then lowered into tubing (10) to a depth such that the lower packing assembly (3) is below coupling (12) and upper packing assembly (2) is stationed just below the upper most top of tubing joint (10). The operator then closes dump valve (25) and engages pump (7), which pumps fluid from reservoir (11) into mandrel (15) via a flexible hose (19). This causes seals (2) and (3) to expand, sealing off the annular space between tubing (10) and mandrel (15). The high pressure fluid being pumped from pump (7) then enters annular space (5) thru mandrel (15). If there is no leak in the annular space, the non-compressible fluid has no place to go, resulting in the pressure in annular space (5) to build up as pump (7) continues pumping fluid.

Pressure transducer (1) is connected to the output of pump (7), and sends pressure information to processor 22. Once the pressure reading from transducer (1) reaches the learned target pressure stored in memory (24), the processor starts clock (23). After a specified period of time (e.g., a pre-programmed hold or delay time), processor (22) again takes a second reading from pressure transducer (1). In some embodiments, an enunciator light is activated by processor (22) to indicate that the target pressure has been reached and/or exceeded. Processor (22) then subtracts the second reading from pressure transducer (1) from the first reading from pressure transducer (1), and divides the difference by the first reading from pressure transducer (1). If this value ((first reading minus second reading) divided by first reading) is less than or equal to 5%, the processor 22 illuminates a first light and a first audible alarm indicating a passing test. If this value is greater than 5%, the processor 22 illuminates a second, different light and a second, different audible alarm indicating a failed test. Once the operator hears the alarm or sees the results of the test, the operator opens dump valve 25, bleeding the pressure from the system. The crew then moves onto the next step: if the test passed, a new length of tubing is lowered in the hole, whereby if the test failed, the crew will pull the section of tubing so as to determine why the test failed. The test is then repeated over and over until all the tubing is run into the well.

In some embodiments, there are two parameters that are programmed into processor (22) that are not changeable by the operator. These two parameters are 1) the time to hold pressure and 2) acceptable tolerance of the decay or bleed off, as these are strictly defined in API RP5A5.

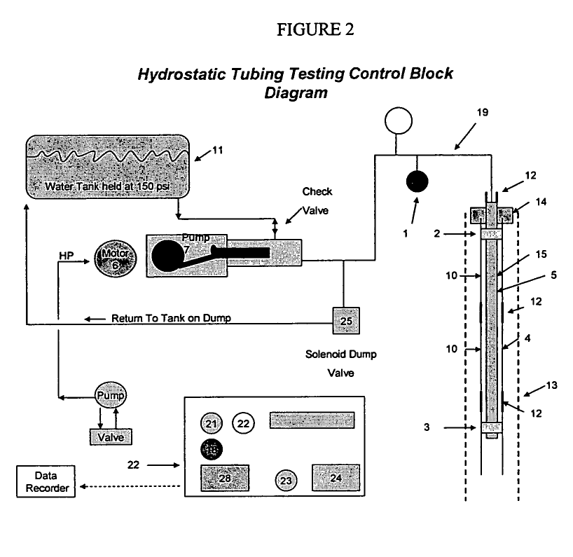

Referring now to FIG. 2, a further embodiment of the present invention is shown. In this embodiment, a PLC circuit (28) is used to control the pump (7) and valve (25). The hydrostatic testing method described above remains the same, however after the test mandrel (15) is lowered into the hole and set for testing, many of the subsequent events that would be handled by the operator are, instead, controlled by the PLC.

The operator would first activate a start switch (18) located on processor (22), which activates a programmed set of events. PLC (28) first signals solenoid valve (25) to close. Once valve (25) is closed, prime mover motor (6) is switched on. In some cases the prime mover is a hydraulic motor, but it could also be a diesel or electric engine as well. Prime mover (6) is mechanically connected to pump (7) which pumps water out of tank (11) into the flexible hose (19) and ultimately into mandrel (15). When the pre-set target or test pressure is reached, PLC (28) signals prime mover (6) to stop. The test proceeds as described above controlled by the processor (22) and follows the same logic for signaling good or bad. At the end of the pre-programmed delay or decay period, PLC (28) then signals valve (25) to open, thereby bleeding off the pressure in mandrel (15).

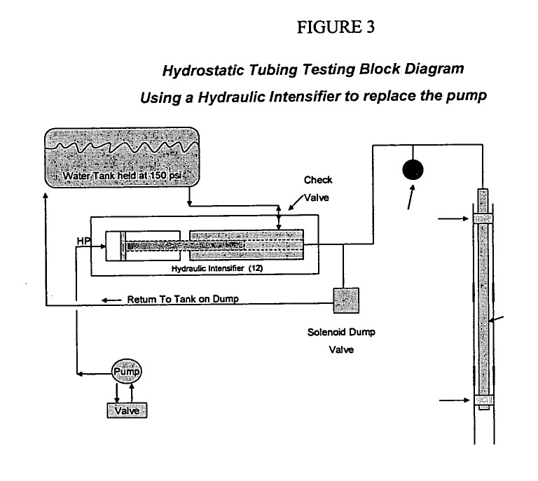

In some embodiments, as shown in FIG. 3, a pump can be replaced using a hydraulic intensifier. In some further embodiments, as shown in both FIG. 1 and FIG. 2, the processor 22 records the pressure readings in a data recorder, so that the operator, supervisor, or any other person can refer to the API test readings to ensure that those standards were met. This type of recording not only is helpful in training and critiquing operator performance, but an untainted record of operations is also useful to provide a client well owner to prove that the hydrostatic test was performed in accordance with API standards.

While the apparatuses and methods of this invention have been described in terms of preferred embodiments, it will be apparent to those of skill in the art that variations may be applied to the process described herein without departing from the concept and scope of the invention. All such similar substitutes and modifications apparent to those skilled in the art are deemed to be within the scope and concept of the invention as it is set out in the following claims.

1. A method for hydrostatically testing tubing, comprising:
setting a tubing target pressure in a processor;
pumping fluid into the tubing, wherein the processor monitors the pressure of the pumped fluid until it reaches the tubing target pressure, after which no more fluid is pumped into the tubing;
automatically taking a first pressure reading of the pumped fluid after the tubing target pressure is reached;
waiting a specified period of time;
automatically taking a second pressure reading of the pumped fluid after the specified period of time has elapsed;
automatically comparing the second pressure reading to the first pressure reading to determine if the difference between the first and second pressure readings is within a specified tolerance.

2. The method of claim 1, wherein once the tubing target pressure is reached, the processor activates an enunciator light.

3. The method of claim 1, wherein the difference between the first and second pressure readings is less than or equal to five percent.

4. The method of claim 1, further comprising illuminating a first light and/or a first audible alarm if the difference between the first and second pressure readings is within the specified tolerance.

5. The method of claim 1, further comprising illuminating a second light and/or a second audible alarm if the difference between the first and second pressure readings is not within the specified tolerance.

6. The method of claim 1, further comprising recording the pressure readings in a data recorder.

7. An apparatus for hydrostatically testing tubing, comprising:
a processor, wherein said processor is capable of being programmed with a tubing target pressure;
a pump for pumping fluid into the tubing until the tubing target pressure is reached;
a pressure transducer for measuring the pressure of the pumped fluid;
wherein the processor automatically takes a first pressure reading of the pumped fluid after the tubing target pressure is reached, then waits a specified period of time, and then automatically takes a second pressure reading of the pumped fluid after the specified period of time has elapsed and then automatically compares the second pressure reading to the first pressure reading to determine if the difference between the first and second pressure readings is within a specified tolerance.

8. The apparatus of claim 6, further comprising an enunciator light that is activated by the processor once the tubing target pressure is reached.

9. The apparatus of claim 6, further comprising illuminating a first light and/or a first audible alarm that is activated by the processor if the difference between the first and second pressure readings is within the specified tolerance.

10. The apparatus of claim 6, further comprising illuminating a second light and/or a second audible alarm that is activated by the processor if the difference between the first and second pressure readings is within the specified tolerance.

11. The apparatus of claim 6, further comprising a PLC circuit that is used to control the pump; wherein the PLC circuit automatically stops the pump after the tubing target pressure is reached.

12. The apparatus of claim 6, further comprising a data recorder, wherein the processor records the pressure readings in the data recorder.
